(19) United States
(12) Patent Application Publication
(10) Pub. No.: US 2006/0292258 A1
(43) Pub. Date: Dec. 28, 2006

(54) Shape retaining member and shape retaining structure

(75) Inventor: Tatsuya Suzuki, Tokyo (JP)

Correspondence Address: HOGAN & HARTSON L.L.P., 1999 AVENUE OF THE STARS, SUITE 1400, LOS ANGELES, CA, 90067, US

(73) Assignee: OLYMPUS CORPORATION

(21) Appl. No.: 11/434,396

(22) Filed: May 15, 2006

(30) Foreign Application Priority Data
May 10, 2005 (JP) 2005-137855

(51) Int. Cl. B28B 1/00

(52) U.S. Cl. 425/175

(57) ABSTRACT

A shape retaining member attached to a wooden piece, which has a predetermined three-dimensional shape and a closed loop end face, includes a main frame that has a contact face having substantially the same shape as the end face; a strip that protrudes from an edge of an inner periphery of the main frame in a direction substantially perpendicular to the contact face; a first tapered protrusion that protrudes from a tip end of the strip towards an outer periphery of the main frame; and a pair of second tapered protrusions each protruding from the contact face near a proximal end of the strip in a direction substantially perpendicular to the contact face and in a direction of protrusion of the strip as well, and being arranged symmetrical about a plane perpendicular to the contact face and passing through the tip end and the apex of the first tapered protrusion.

### CROSS-REFERENCE TO RELATED APPLICATIONS

This application is a continuation of PCT international application Ser. No. PCT/JP2006/305476 filed Mar. 14, 2006 which designates the United States, incorporated herein by reference, and which claims the benefit of priority from Japanese Patent Application No. 2005-137855, filed May 10, 2005, incorporated herein by reference.

### BACKGROUND OF THE INVENTION

1. Field of the Invention

The present invention relates to a shape retaining member and a shape retaining structure for retaining a predetermined three-dimensional shape of a wooden piece.

2. Description of the Related Art

Casings that cover electronic equipments such as cameras and portable telephones are mostly made of synthetic resin or metal. The shapes of such casings are retained by shape retaining members for preventing external forces from deforming the casing and thus retaining the shape of the casing. The shape retaining members are secured to the casing by screws, caulking, or the like.

Meanwhile, techniques of forming wooden casings attract attentions. With a wide variety of grain patterns of wooden materials as being natural materials, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden materials: a wooden board is softened with water absorption and compressed; the compressed wooden board is cut along a direction substantially parallel with a direction in which the compressive force is applied, whereby a primary fixed product with a board-like shape is obtained; and the primary fixed product is deformed into a desired three-dimensional shape under heat and moisture (for example, see Japanese Patent No. 3078452 Publication). Further, according to another conventional technique, a softened wooden sheet is compressed and temporarily secured in a prepared mold and left in the mold until the wooden board recovers. Thus a wooden product with a desired shape can be obtained (see, for example, Japanese Patent Application Laid-Open No. H11-77619 Publication).

### SUMMARY OF THE INVENTION

A shape retaining member according to one aspect of the present invention is attached to a wooden piece, which has a predetermined three-dimensional shape and a closed loop end face, for retention of the shape of the wooden piece, and includes a main frame portion that has a contact face which has substantially the same shape as that of the end face of the wooden piece; a protruding strip that protrudes from an edge of an inner periphery of the main frame portion in a direction substantially perpendicular to the contact face; a first tapered protruding portion that protrudes from a tip end portion of the protruding strip towards an outer periphery of the main frame portion; and a pair of second tapered protruding portions each protruding from the contact face near a proximal end of the protruding strip in a direction substantially perpendicular to the contact face and in a direction of protrusion of the protruding strip as well, and being arranged symmetrical about a plane perpendicular to the contact face and passing through the tip end portion of the protruding strip and the apex of the first tapered protruding portion.

A shape retaining structure according to another aspect of the present invention includes a wooden piece having a predetermined three-dimensional shape; and the shape retaining member according to the present invention attached to the wooden piece. The contact face of the main frame portion comes in contact with the end face of the wooden piece, the first tapered protruding portion is buried into an internal surface of the wooden piece, and the second tapered protruding portion is pressed into the end face of the wooden piece.

### BRIEF DESCRIPTION OF THE DRAWINGS

FIG. 1 is a perspective view of a compressed wood product formed from a compressed wooden piece to which a shape retaining member according to a first embodiment of the present invention is attached;

FIG. 2 is a perspective view of the compressed wooden piece, which is a part of the compressed wood product of FIG. 1;

FIG. 3 is a schematic view of a configuration of the shape retaining member according to the first embodiment of the present invention;

FIG. 4 is a partially enlarged perspective view of protruding portions and surrounding portion thereof, of the shape retaining member according to the first embodiment of the present invention;

FIG. 5 is a sectional view taken along line A-A of FIG. 1;

FIG. 6 is a diagram schematically showing a compression process of a wooden piece;

FIG. 7 is a vertical sectional view of the wooden piece during application of compressive force (where deformation of the wooden piece is nearly finished);

FIG. 8 is an enlarged sectional view of a part of the wooden piece and a second tapered protruding portion where the second tapered protruding portion is pressed into an end face of the wooden piece in the process where the shape retaining member is attached to the wooden piece; and

FIG. 9 is an enlarged sectional view of the part of the wooden piece and a first tapered protruding portion where the first tapered protruding portion is buried into an internal surface of the wooden piece in the process where the shape retaining member is attached to the wooden piece.

### DETAILED DESCRIPTION OF THE PREFERRED EMBODIMENTS

Preferred embodiments (hereinbelow simply referred to as “embodiments”) of the present invention will be described below with reference to the accompanying drawings.

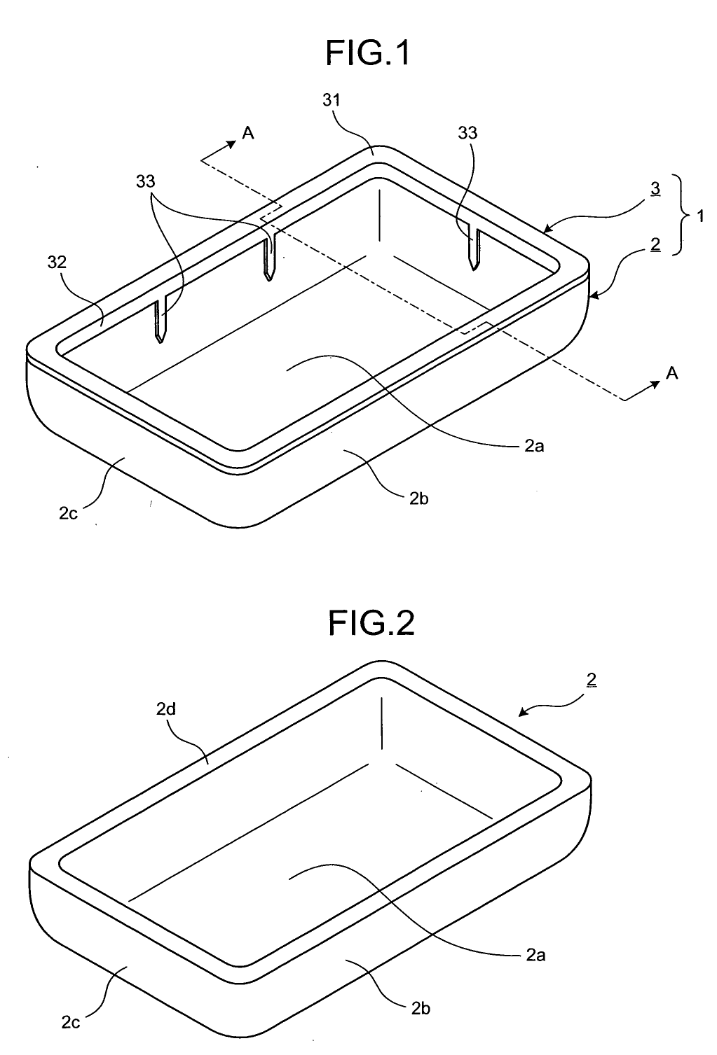

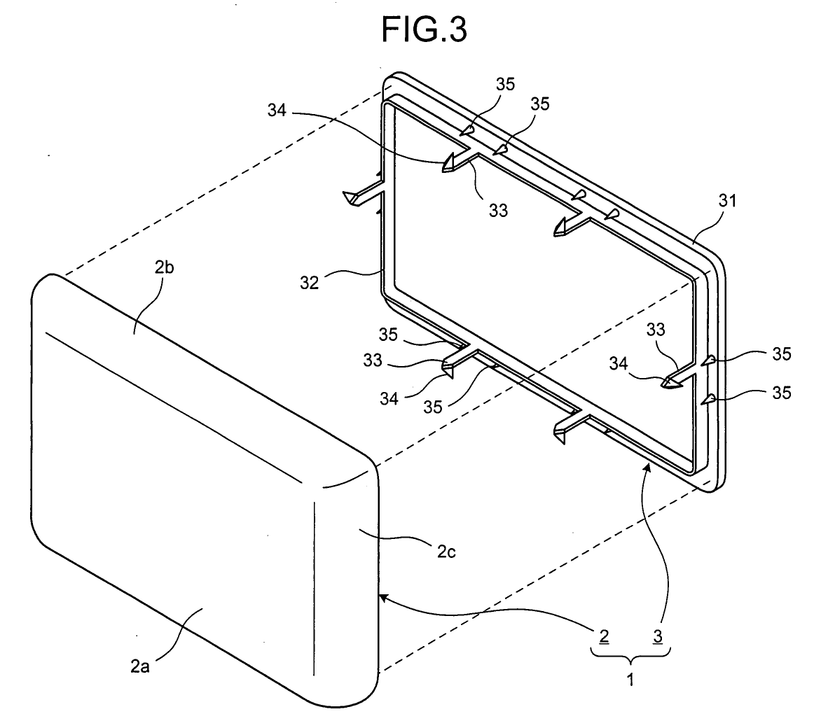

FIG. 1 is a perspective view of a configuration of a compressed wood product which includes a wooden piece formed through compression (compressed wooden piece) and a shape retaining member of the first embodiment of the present invention, which is attached to the compressed wooden piece. FIG. 2 is a perspective view of a configuration of the compressed wood of the compressed wood product shown in FIG. 1. The compressed wood product 1 shown in FIG. 1 includes a substantially bowl-like wooden piece 2 (wooden piece), and a metallic shape retaining member 3 attached to the wooden piece 2. FIG. 3 is an exploded perspective view of the compressed wood product 1 of FIG. 1 viewed from a bottom side thereof. The configuration of the wooden piece 2 and the shape retaining member 3 will be described below with reference to FIGS. 1 to 3.

The wooden piece 2 includes a substantially rectangular main plate portion 2a, two side plate portions 2b that extend from two sides substantially parallel to a lengthwise direction of the main plate portion 2a making a predetermined angle to the main plate portion 2a, respectively, two side plate portions 2c that extend from another two sides substantially parallel to a breadthwise direction of the main plate portion 2a making a predetermined angle to the main plate portion 2a, respectively, and a closed loop end face 2d. The wooden piece 2 is, as described later, formed by compressing unprocessed raw wood. The raw wood to be employed may be, for example, Japanese cypress, hiba cedar, paulownia; Japanese cedar, pine, cherry, zelkova, ebony wood, teak, mahogany, and rosewood.

The wooden piece 2 is illustrated without indications of grain patterns in FIGS. 1 to 3, since the present embodiment can be realized regardless of the grain patterns of the wooden piece 2. The wooden piece 2 can be cut out from the raw material, i.e., from the raw wood, based on various conditions such as intended use, required strength, and desirable appearance of the wooden piece 2 obtained as a resulting product processed from the raw wood. A most appropriate piece can be selected from a flat-grain piece, a straight-grain piece, a piece with an intermediate grain pattern of the flat-grain and the straight-grain, and an end-grain piece.

A configuration of the shape retaining member 3 will be described. The shape retaining member 3 includes a main frame portion 31 having a contact face 36 which contacts with the end face 2d of the wooden piece 2 and has substantially the same shape as that of the end face 2d, and a guide portion 32 which extends in a direction substantially perpendicular to the contact face 36 of the main frame portion 31 from an inner periphery of the main frame portion 31 and functions as a guide when the shape retaining member 3 is attached to the wooden piece 2.

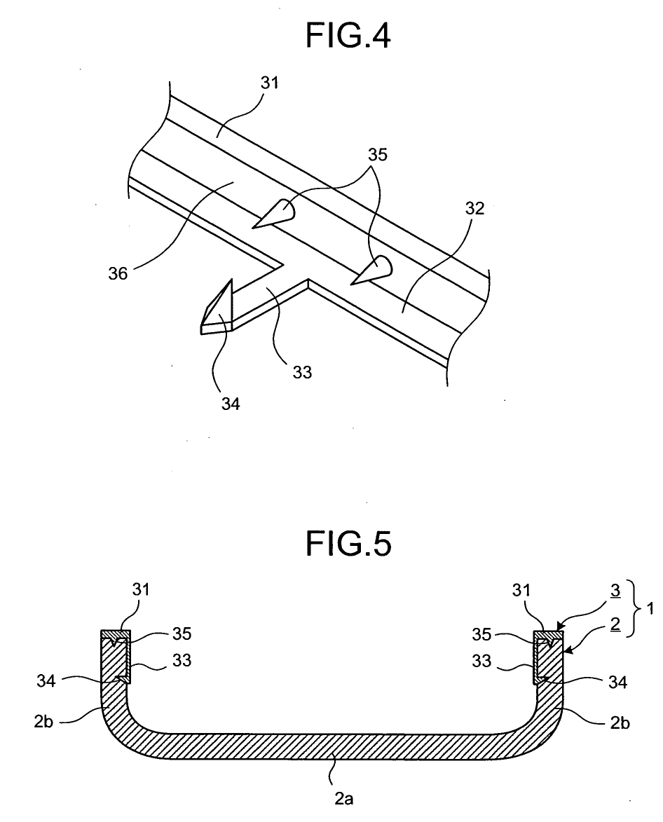

The shape retaining member 3 further includes portions for configuring a shape retaining structure according to the present embodiment. FIG. 4 is an enlarged perspective view showing a configuration of the portions which form the shape retaining structure. FIG. 5 is a schematic view of a configuration of the shape retaining structure according to the present embodiment, and is a sectional view taken along line A-A of FIG. 1. As shown in FIGS. 4 and 5, the shape retaining member 3 includes a protruding strip 33 which protrudes in a direction perpendicular to the contact face 36 of the main frame portion 31 from an edge of the guide portion 32, a trigonal pyramidal protruding portion 34 (first protruding portion) which protrudes from a tip end portion of the protruding strip 33 towards an outer periphery of the main frame portion 31, and two circular conic protruding portions 35 (second protruding portions) which are provided near a proximal end of the protruding strip 33 and protrudes in the same direction as the direction of protrusion of the guide portion 32.

The protruding portion 34 is buried into the internal surface of the side plate portion 2b or 2c and serves to prevent the main frame portion 31 from falling off from the end face 2d of the wooden piece 2 (retaining function). Two protruding portions 35 are arranged in pairs symmetrical about a plane perpendicular to the contact face 36 and passing through the tip end portion of the protruding strip 33 and the apex of the protruding portion 34. Two protruding portions 35 are pressed into the end face 2d. A pair of protruding portions 35 serves to suppress an excessive outward deformation of the side plate portions 2b and 2c which may be caused when a force is applied to the wooden piece 2 in a direction substantially parallel to the thickness direction of the main plate portion 2a (vertically upward direction in FIG. 5) from the bottom face of the main plate portion 2a.

The shape retaining member 3 is formed from plural groups (six groups in FIG. 3) of the-protruding strip 33, the protruding portion 34, and a pair of protruding portions 35. More specifically, two groups are arranged along each long side of the rectangle formed by the main frame portion 31 with the interval same as that between another two groups, and one group is arranged on each short side. Thus, the shape retaining member 3 is arranged symmetrically about two planes; one plane is passing through the center of gravity of the shape retaining member, is parallel to the long side of the main frame portion 2a, and is perpendicular to the short side of the main frame portion 2a, and another plane is passing through the center of gravity of the shape retaining member, is perpendicular to the long side of the main frame portion 2a, and is parallel to the short side of the main frame portion 2a. Such a symmetry of the shape retaining member 3 assures even more stable shape retention of the wooden piece 2.

For a further enhancement of the shape stability of the compressed wood product 1, it is more preferable that the apexes of the protruding portion 34 and a pair of the protruding portions 35 forming a group be arranged at the same distance from one another. Here, the protruding portion 34 may have a tapered shape other than the trigonal pyramid (e.g., a circular cone, a polygonal pyramid). Similarly, the protruding portion 35 may have a tapered shape other than the circular cone (e.g., a polygonal pyramid). In the case of the shape retaining member 3 according to the present embodiment, it is generally sufficient that at least two groups are arranged symmetrically about one of the planes passing through the center of gravity of the shape retaining member among plural groups of protruding strip 33, the protruding portion 34, and a pair of the protruding portions 35.

The shape retaining member 3 with the above-described configuration may be formed from a significantly harder material than the wooden piece 2, and may be formed from non-metal material, such as super engineering plastic represented by polyimide.

A method of processing the wooden piece 2 will be described. First, a wooden piece 21 is taken out into a predetermined shape from the uncompressed raw wood by a technique such as cutting. At this point, the volume of the taken-out wooden piece should be larger than the volume of the finished piece by an amount to be decreased during a compression process described later. Here, the wooden piece may be taken out into a flat plate.

Thereafter, the wooden piece taken out from the raw wood is left in a water vapor atmosphere of high temperature and high pressure for a predetermined time period, and is made to absorb excessive moisture to be softened. Here, the high temperature means 100 to 230° C. and more preferably approximately 180 to 200° C. in temperature, and the high pressure means 0.1 to 3 MPa (MegaPascal) and more preferably approximately 0.45 to 2.5 MPa in pressure. Alternatively, the wooden piece 21 may be heated by application of high-frequency electromagnetic wave such as microwave rather than by being left in the waver vapor atmosphere as described above.

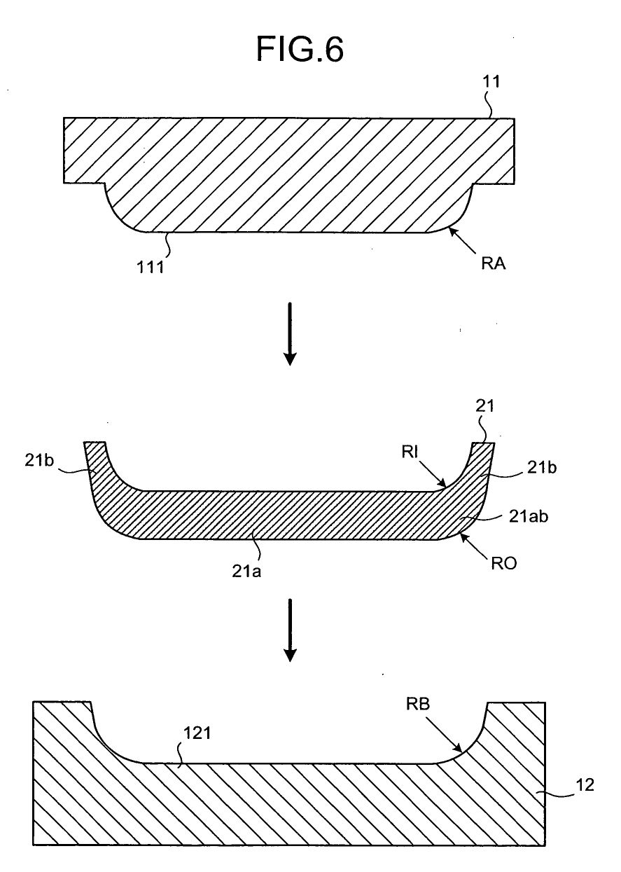

Thereafter, the softened wooden piece is compressed in the same water vapor atmosphere. FIG. 6 schematically shows how the compression process is performed. In FIG. 6, the taken-out wooden piece 21 is sandwiched and compressed between a pair of metal molds 11 and 12. The metal mold 11 which is employed for applying compressive force to the wooden piece 21 from above during compression has a protrusion 111 shaped so as to fit with the internal surface of the wooden piece 21. When the radius of curvature of an internal surface of a curved portion 21ab extending from the main plate portion 21a to the side plate portion 21b of the wooden piece 21 is represented as RI, and the radius of curvature of a curved surface, which abuts the curved portion 21ab during compression, on the protrusion 111 is represented as RA, relation represented as RI>RA needs to hold for appropriate compression of the wooden piece 21. In other words, the wooden piece 21 is taken out and the protrusion 111 is designed so as to satisfy the above relation.

On the other hand, the metal mold 12 which is employed to apply compressive force to the wooden piece 21 from below has a depression 121 that fits the external surface of the wooden piece 21. When the radius of curvature of an external surface of the curved portion 21ab extending from the main plate portion 21a to the side plate portion 21b of the wooden piece 21 is represented as RO, and the radius of curvature of a curved surface, which abuts the external surface of the curved portion 21ab during compression, on the depression 121 is represented as RB, relation represented as RO>RB needs to hold for appropriate compression of the wooden piece 21. In other words, the wooden piece 21 is taken out and the depression 121 is designed so as to satisfy the above relation.

In the present embodiment, the metal molds 11 and 12 are formed so that compression rate in the thickness direction is substantially uniform at respective portions of the wooden piece 21 (here, the compression rate means a ratio of decrease in the thickness of the wooden piece by the compression to the thickness of the wooden piece before the compression). Thus, the color tone of the wooden piece 2 obtained after the compression can be made uniform.

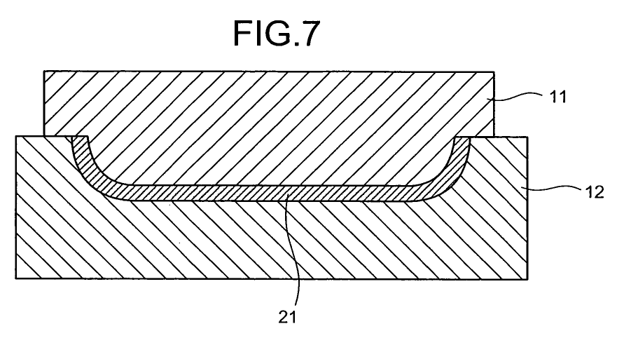

FIG. 7 is a diagram which shows that the softened wooden piece 21 arranged in a predetermined position is sandwiched and compressed by the metal molds 11 and 12. In FIG. 7, the wooden piece 21 is subjected to the compressive force while its deformation being nearby completed into the three-dimensional shape corresponding to the shape of a gap between the metal molds 11 and 12. After being left in the compressed state shown in FIG. 7 for a predetermined time period, the wooden piece 21 is released from compression as the metal molds 11 and 12 are separated from each other. Then, the water vapor atmosphere of high temperature and high pressure as described above is removed and the wooden piece 21 is dried. Thus, the formation of the wooden piece 2 is completed. As a result of the compression process as described above, the wooden piece 2 comes to have a substantially uniform thickness, which is approximately 30 to 50% of the thickness of the wooden piece 21 before the compression process.

Generally, the wooden piece 21 can be compressed to approximately 20% the thickness before the compression. In the present embodiment, however, the compression on the wooden piece 21 is not performed to such a limit value. Hence, the finished wooden piece 2 still contains some space inside. The existence of such space prevents changes in the appearance of the wooden piece 2 such as bulging which may be caused by the insertion of the protruding portion 34 or the press fit of the protruding portion 35.

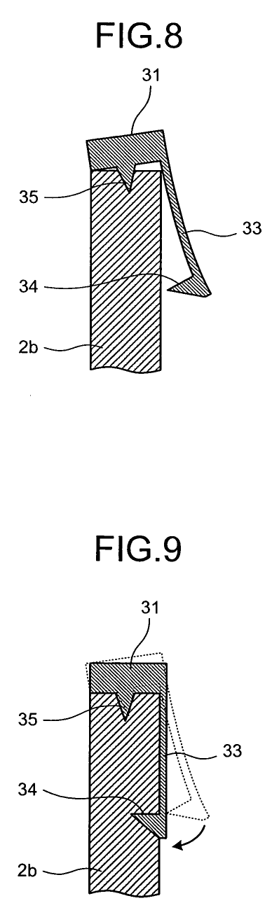

An outline of an attachment process of the shape retaining member 3 to the wooden piece 2 will be described. FIGS. 8 and 9 schematically show how the protruding portion 34 is fit into the wooden piece 2 and how the protruding portion 35 is pressed into the wooden piece 2, and are partially enlarged sections at the same section shown in FIG. 5. First, the protruding portion 35 is pressed into the end face 2d. At this moment, the apex of the trigonal pyramid of the protruding portion 34 has not yet been buried into the side plate portion 2b as shown in FIG. 8, and the protruding strip 33 bends in a direction away from the side plate portion 2b. In the state shown in FIG. 8, the protruding portion 35 has not been completely pressed into the end face 2d.

Then, the main frame portion 31 is pressed against the end face 2d and the protruding portion 35 is pressed further into the side plate portion 2b. On the other hand, a portion around the bottom face of the protruding portion 34 is pressed against the side plate portion 2b, and the protruding portion 34 is buried into the internal surface of the side plate portion 2b. Thus, the attachment of the group of the protruding portion 34 and the pair of protruding portions 35 is completed as shown in FIG. 9.

In the manner as described above, the group of the protruding portion 34 and the pair of the protruding portions 35 is attached to the side plate portion 2b. Other groups of protruding portion 34 and the pair of the protruding portions 35 may be similarly attached one after another. With regard to the shape retaining member 3 having a shape as shown in FIG. 3, a swift attachment of the shape retaining member 3 to the wooden piece 2 can be realized when the shape retaining member 3 is attached to the main frame portion 31 by the side of the rectangle formed by the main frame portion 31. When the shape retaining member 3 is formed from a hard metal, the protruding strip 33 bends only slightly, and it is not easy to attach all the groups of the protruding portion 34 and the pair of protruding portions 35 to the wooden piece 2 by the same process. In this case, after the protruding portions 34 and 35 on one side of the rectangle of the main frame portion 31 are attached to the wooden piece, other protruding portions 34 and 35 on other sides of the rectangle may be attached to the wooden piece 2 while being properly positioned with the use of a suitable jig.

According to the present embodiment of the present invention as described above, the shape retaining member includes the main frame portion having the contact face with substantially the same shape as that of the closed loop end face of the wooden piece having the predetermined three-dimensional shape, the protruding strip that protrudes from the edge of the inner periphery of the main frame portion in the direction substantially perpendicular to the contact face, the first tapered protruding portion that protrudes from the tip end portion of the protruding strip towards the outer periphery of the main frame portion, and a pair of the second tapered protruding portions each protruding from the contact face near the proximal end of the protruding strip in a direction substantially perpendicular to the contact face and in a direction of the protrusion of the protruding strip as well, and being arranged symmetrical about the plane perpendicular to the contact face and passing through the tip end portion of the protruding strip and the apex of the first tapered protruding portion. Thus, the shape retaining member and the shape retaining structure allow for an easy attachment that does not accompany degradation in the appearance of the wooden piece, while realizing a precise suppression of the deformation of the wooden piece and stable shape retention.

Further, according to the present embodiment, the compression rate of the wooden piece is controlled so as not to reach the limit value. Therefore, even if the wooden piece is significantly thin (for example, even if the thickness thereof is approximately 1.6 mm), the appearance of the wooden piece, i.e., the appearance of the side faces, into which the protruding portions are not pressed or buried, is not negatively affected by the shape retaining member.

The exemplary embodiment of the present invention is described in detail above. The present invention, however, should not be limited to the present embodiment. In the above embodiment, the shape retaining member is attached to the bowl-like wooden piece. The shape retaining member, however, may include additional groups of the first and the second protruding portions symmetrically formed about the main frame portion similarly to the above described protruding portions, so that two wooden pieces can be joined together by one shape retaining member and formed into a casing. In such case, the shape retention of the casing can be realized by only one shape retaining member.

Thus, the present invention may include various embodiments not specifically mentioned above, and various modifications in design or the like can be made within the scope of technical concepts defined in the appended claims.

What is claimed is:

1. A shape retaining member attached to a wooden piece, which has a predetermined three-dimensional shape and a closed loop end face, for retention of the shape of the wooden piece, comprising:
a main frame portion that has a contact face which has substantially the same shape as that of the end face of the wooden piece;
a protruding strip that protrudes from an edge of an inner periphery of the main frame portion in a direction substantially perpendicular to the contact face;
a first tapered protruding portion that protrudes from a tip end portion of the protruding strip towards an outer periphery of the main frame portion; and
a pair of second tapered protruding portions each protruding from the contact face near a proximal end of the protruding strip in a direction substantially perpendicular to the contact face and in a direction of protrusion of the protruding strip as well, and being arranged symmetrical about a plane perpendicular to the contact face and passing through the tip end portion of the protruding strip and the apex of the first tapered protruding portion.

2. The shape retaining member according to claim 1, wherein
the protruding strip, the first tapered protruding portion, and the pair of the second tapered protruding portions form a group, the group being plural in number,
at least two groups among the plural groups are arranged symmetrically about one of planes passing through a center of gravity of the shape retaining member.

3. The shape retaining member according to claim 2, wherein
an apex of the first tapered protruding portion is arranged at a same distance from apexes of the second tapered protruding portions within each group.

4. The shape retaining member according to claim 1, wherein
the main frame portion has a closed shape.

5. The shape retaining member according to claim 4, wherein
an apex of the first tapered protruding portion is arranged at a same distance from apexes of the second tapered protruding portions within each group.

6. The shape retaining member according to claim 1, wherein
the shape retaining member is made of a material containing metal.

7. A shape retaining structure comprising:
a wooden piece having a predetermined three-dimensional shape; and
the shape retaining member according to claim 1 attached to the wooden piece, wherein
the contact face of the main frame portion comes in contact with the end face of the wooden piece,
the first tapered protruding portion is buried into an internal surface of the wooden piece, and
the second tapered protruding portion is pressed into the end face of the wooden piece.

8. The shape retaining structure according to claim 7, wherein
the wooden piece is formed through compression molding.

9. The shape retaining structure according to claim 8, wherein
a compression rate in a thickness direction of the wooden piece is substantially uniform.
